(19) United States
(12) Patent Application Publication
(10) Pub. No.: US 2014/0337043 A1
(43) Pub. Date: Nov. 13, 2014

(54) CONTACT LENS CUTTING FILE DISTRIBUTION SYSTEM AND METHOD

(71) Applicants: ANTHONY DEZILVA, Surprise, AZ (US); JEROME A. LEGERTON, Jupiter, FL (US)

(72) Inventors: ANTHONY DEZILVA, Surprise, AZ (US); JEROME A. LEGERTON, Jupiter, FL (US)

(21) Appl. No.: 13/891,729

(22) Filed: May 10, 2013

(51) Int. Cl. G06Q 30/06; G06Q 50/22

(52) U.S. Cl. CPC G06Q 30/0621; G06Q 50/22
USPC 705/2

(57) ABSTRACT

A non-transitory computer readable medium having computer executable program code embodied thereon, the computer executable program code configured to cause a computing device to: receive an order for cutting a contact lens from a contracted manufacturer at an exchange; uniquely identify and authorize the manufacturer and a user entering the order; pre-validate the order for consistency based on predetermined rules; place the order with an exchange engine and authenticate the order; determine whether a required parameter file is already generated and available via a cutting file database; if the required parameter file already exists, instruct the cutting file database to package the available data and deliver the appropriate encrypted package back to the engine for delivery to a lathe gateway computer; if the required parameter file does not exist, forward the order to a lathe file generator to create the parameter file and enter it into the cutting file database; and deliver the encrypted package to the lathe gateway computer.

### FIELD OF THE INVENTION

The present invention relates to a contact lens cutting file distribution system and method.

### BRIEF SUMMARY OF EMBODIMENTS OF THE INVENTION

Embodiments of the invention provide a contact lens cutting file distribution system and method.

One embodiment is directed toward a non-transitory computer readable medium having computer executable program code embodied thereon, the computer executable program code configured to cause a computing device to: receive an order for cutting a contact lens from a contracted manufacturer at an exchange; uniquely identify and authorize the manufacturer and a user entering the order; pre-validate the order for consistency based on predetermined rules; place the order with an exchange engine and authenticate the order; determine whether a required parameter file is already generated and available via a cutting file database; if the required parameter file already exists, instruct the cutting file database to package the available data and deliver the appropriate encrypted package back to the engine for delivery to a lathe gateway computer; if the required parameter file does not exist, forward the order to a lathe file generator to create the parameter file and enter it into the cutting file database; and deliver the encrypted package to the lathe gateway computer.

In the above computer readable medium, the order can be received via a Web based solution or a mobile device based solution. In addition, the manufacturer and user can be uniquely identified and authorized by verifying a userID and password entered by the person. The computer executable program code may be further configured to cause the computing device to require the manufacturer to certify in order to produce a particular lens type and/or to restrict the user to only order product authorized for the selected manufacturer to produce. In some embodiments, the order is authenticated using a two-step, two-tier authentication system wherein the communication is encrypted and then authorized using a unique identifier assigned to the user. The exchange engine listens for an incoming encrypted order request using, e.g., an Internet based order process, an internal job fulfillment request, or a poll from a manufacturer lathe gateway computer requesting order fulfillment.

Another embodiment of the invention is directed toward a system, comprising: means for receiving an order for cutting a contact lens from a contracted manufacturer at an exchange; means for uniquely identifying and authorizing the manufacturer and a user entering the order; means for pre-validating the order for consistency based on predetermined rules; means for placing the order with an exchange engine and authenticating the order; means for determining whether a required parameter file is already generated and available via a cutting file database; means for instructing the cutting file database to package the available data and deliver the appropriate encrypted package back to the engine for delivery to a lathe gateway computer if the required parameter file already exists; means for forwarding the order to a lathe file generator to create the parameter file and enter it into the cutting file database if the required parameter file does not exist; and means for delivering the encrypted package to the lathe gateway computer.

In some embodiments, the system further comprises means for requiring the manufacturer to certify in order to produce a particular lens type and/or means for authenticating the order using a two-step, two-tier authentication process wherein the communication is encrypted and then authorized using a unique identifier assigned to the user. In certain embodiments, the system further comprises a means for determining whether the required parameter file is already generated and available via cutting file database.

An additional embodiment of the invention is directed toward a method for contact lens cutting file distribution, comprising: providing a dedicated gateway computer provisioned with a scheduling and order entry module that accepts an order from an exchange engine, the order including lens parameters, patient information and order placement; securely downloading a lathe cutting file; and providing an interface to a lathe to transfer the cutting file in order to complete a cutting process. In some cases, the method further comprises cutting a contact lens according to the lens parameters, and then determining whether the order is complete. The method may also comprise securely deleting the lathe file if the order is complete, as well as updating internal databases identifying the completion of the order and invoicing for royalty payments. In some embodiments, the method includes polling proprietary servers on a pre-set timer for updated statuses or work order payload.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

FIG. 1 is a diagram illustrating an exemplary contact lens cutting file distribution system and method, in accordance with an embodiment of the invention.

FIG. 2 is a diagram illustrating an exemplary manufacturer architecture for a contact lens cutting file distribution system and method, in accordance with an embodiment of the invention.

FIG. 3 is a diagram illustrating an exemplary computing module that may be used to implement any of the embodiments disclosed herein.

These figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward a contact lens cutting file distribution system and method. One goal of the distribution system is to provide contracted manufacturers the ability to acquire the required lathe files, and to produce proprietary contact lenses in a secure, accountable solution.

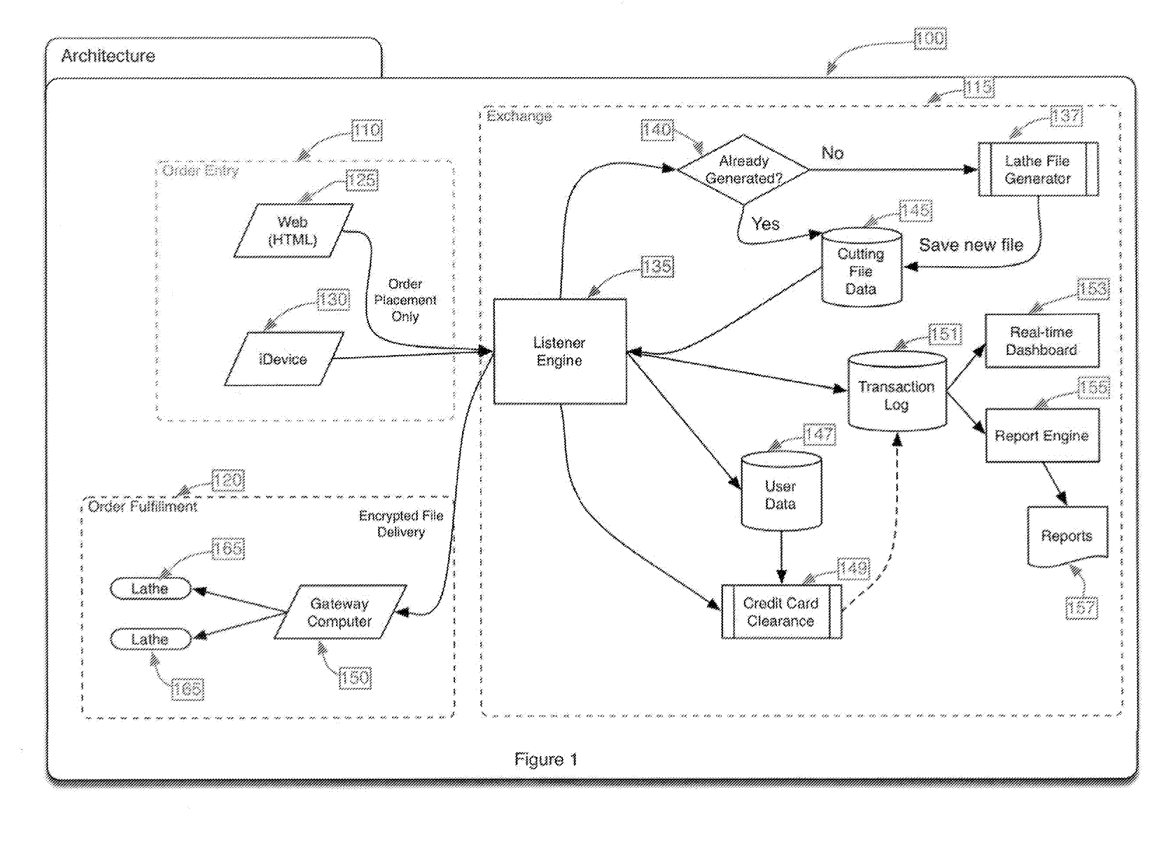

FIG. 1 is a diagram illustrating an exemplary contact lens cutting file distribution system and method, in accordance with an embodiment of the invention. The illustrated system 100 comprises three major components including order entry 110, exchange 115, and order fulfillment 120.

With continued reference to FIG. 1, during order entry 110, a contracted manufacturer places an order with the exchange 115 via a Web based solution 125 (e.g., HTML) or a mobile device based solution 130. By entering a userID and password, the manufacturer and person entering the order are uniquely identified and authorized. In some embodiments, manufacturers are required to certify in order to produce a particular lens type, and the user entering the order can only order product authorized for that manufacturer to produce. Once an order is complete, the order entry components pre-validate the order for consistency based on predetermined rules and, if validated, the order is placed with an exchange engine 135 (e.g., via a secure XML POST process). In some embodiments, the communication is encrypted (e.g., using a 256-bit 2048 bit SSL key) and authorized (e.g., using a unique GUID assigned to each user within the system). This two-step, two-tier authentication system prevents a majority of hacking attempts to place unauthorized or fraudulent orders. Additional periodic audits (reports) generated by the system can provide subsequent manual tools to verify the integrity of the system.

With further reference to FIG. 1, the exchange 115 is located on one or more secure servers at a predetermined location. The exchange 115 includes engine 135, lathe file generator 137, lathe file gatekeeper 140 and SQL/database server 142 including cutting file database 145, user data database 147, credit card clearance engine 149, transaction log database 151, real-time dashboard 153, and report engine 155 for producing reports 157. The engine 135 may comprise an XML Listener Engine that “listens” for an incoming request either via an Internet based order process, an internal job fulfillment request, or a poll from a manufacturer lathe gateway computer 150 requesting order fulfillment. The engine 135 authenticates the encrypted request via its SSL key and the unique identifier assigned to the user or gateway computer 150. Once authenticated, engine 135 performs the required action, or forwards the request and its payload to the relevant systems.

Lathe file gatekeeper 140 is a software component that determines whether the required parameter file is already generated and available via cutting file database 145. If the parameters already exist, lathe file gatekeeper 140 instructs cutting file database 145 to package the available data and deliver the appropriate encrypted package back to the engine 135 for delivery to the appropriate lathe gateway computer 150. If the required parameters do not exist, the request is forwarded to lathe file generator 137 to create the requested parameter file and enter it into cutting file database 145. The cutting file database 145 then packages and delivers the encrypted package to the engine 135 for delivery to the appropriate lathe gateway computer 150.

SQL/Database Server 142 maintains the following information in cutting file database 145 and/or user data database 147: (i) a generated cutting file repository; (ii) user data (e.g., UID/Password, manufacturer information, Authorizations, Order History, etc.); (iii) financial transactions; and (iv) a system log of every transaction/request, whereby all transactional activity is timestamped and archived in transactional log database 151 in real-time. Credit card clearance engine 149 can be integrated with a credit card clearance engine (e.g., Pay-Pal, Quicken) to automatically process credit card transactions for order requests placed through the exchange 115. This information can be scaled on a per-transaction or per-time period basis.

In the illustrated embodiment, the transactional log database 151 is used to feed the real-time dashboard 153 and report engine 155. The real-time dashboard 153 can be used to display statistics, exchange performance data, and activity history. Logic built into the dashboard 153 can be employed to highlight or warn users based on the frequency of activity. Real-time dashboard 153 may also contain a section with alerts based on system generated criteria to flag potential suspicious activity including input from Intrusion Detection and Anti-Virus sensors. In some embodiments, the real-time dashboard 153 may also be employed to notify customers of order delivery, order completion, or transactional activity reporting to provide constant communication, thereby reducing the need for a large customer service phone-bank typical in this industry.

With continued reference to FIG. 1, the report engine 155 may comprise a timed batch process component that generates pre-defined reports 157 on a periodic basis, and then distributes these reports 157 to relevant stakeholders via automated email. In some embodiments, the reports 157 can include transactional history reports that are delivered to partnering manufacturers on a pre-defined regular basis to provide notice of performance/charges for participating in the exchange.

Lathe gateway software is delivered/installed at a designated gateway computer 150 at each contracted manufacturer. The lathe gateway software polls the engine 135 at predetermined intervals for the delivery of order packages. If an order package is found, the gateway software will automatically download the encrypted package and store it until a request is initiated by a lathe 165. When a lathe 165 makes a request by order number, the gateway software matches up the appropriate file and delivers the encrypted payload to the lathe 165 for decryption. The gateway software also updates the engine 135 by flagging the order as complete. A software component on the lathe 165 de-crypts the lathe file based on a pre-defined key, and stores the unencrypted file in volatile memory (e.g., temporary RAM disk). The program returns control back to the lathe 165 for processing of that file, and deletes it when cutting is complete. As the file is in volatile memory, any attempts to tamper or access the respective file results in its disappearance, thereby preventing the ability to store for future use. As a result, each file is a ‘one-time-use’ file. In one embodiment of the invention errors or re-cuts are processed as a new request. Such error and re-cut uses are appropriately flagged so monthly financial reconciliation can appropriately credit back the manufacturer.

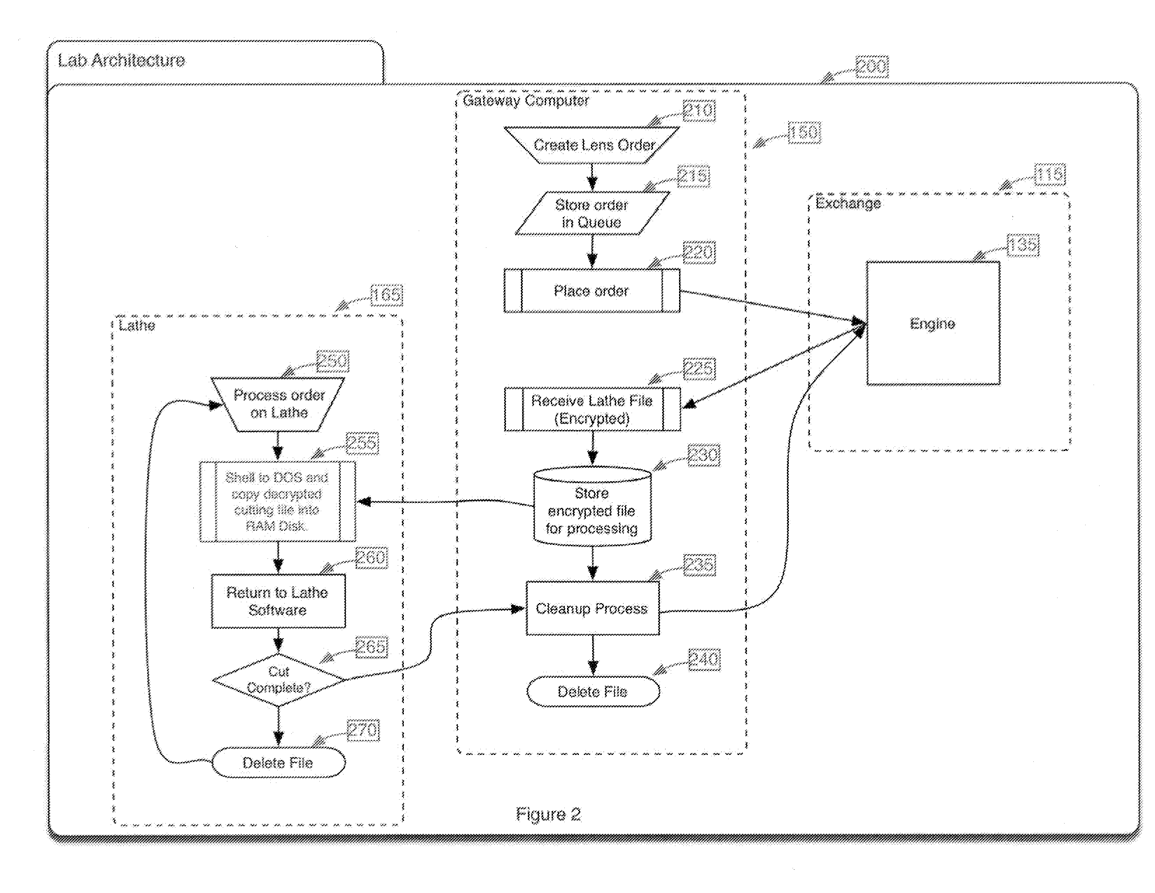

FIG. 2 is a diagram illustrating an exemplary manufacturer architecture 200 for a contact lens cutting file distribution system and method, in accordance with an embodiment of the invention. Each contracted manufacturer location provides a dedicated gateway computer 150 that is provisioned with an implementation of a proprietary software module. This software module may contain a scheduling and order entry module that accepts lens parameters, patient information and order placement from the exchange engine 135. The gateway computer 150 communicates with the exchange engine 135 via the Internet. In operation, the gateway computer 150 completes the order transaction and securely downloads at least one encrypted lathe cutting file to complete the order. Specifically, gateway computer 150 creates a lens order in operation 210, stores the order in a queue in operation 215 and places the order in operation 220.

Gateway computer 150 provides an interface to a lathe 165 to securely and temporally transfer the decrypted cutting file in order to complete the cutting process. In operation 225, gateway computer 150 receives an encrypted lathe file, and then stores it for processing in operation 230. In operation 235, gateway computer 150 updates both internal and databases identifying the completion of the job and invoicing for royalty payments. Gateway computer 150 then securely deletes the lathe file 145 in operation 240 so no further use of the lathe file 145 is possible. In some embodiments, the gateway computer 150 contains reporting features on utilization and financial criteria. In further embodiments, gateway computer 150 polls proprietary servers on a pre-set timer for updated statuses or work order payload.

Still referring to FIG. 2, lathe 165 processes an order in operation 250. Operation 255 involves copying the decrypted cutting file into, for example, a RAM disk. In operation 260, the file is returned to lathe software. In operation 265, the lathe 165 determines whether the cut is complete. If so, the lathe 165 securely deletes the file in operation 270.

In some embodiments of the invention, the system maintains redundant web servers customized by geographic region based on existing laws and criteria. These web servers monitor for communication from manufacturer gateway computers 150 and provide status updates and ACK/NACK acknowledgements of successful transmittal. In addition, these servers identify manufacturer communications and authenticate them as genuine and valid. The servers may also be used to: (i) validate the integrity of order details and place in Order Queue for processing; (ii) acquire encrypted lathe files from Order Queue and hold for next poll by the manufacturer gateway; (iii) deliver encrypted files to manufacturer gateways and monitor for successful transmission, and delete file off server once successfully delivered; (iv) update order status records as delivered and await order completion confirmation; and (v) send emails and provide real-time reporting via dashboard on order status and utilization statistics.

As used herein, the term “set” may refer to any collection of elements, whether finite or infinite. The term “subset” may refer to any collection of elements, wherein the elements are taken from a parent set; a subset may be the entire parent set. The term “proper subset” refers to a subset containing fewer elements than the parent set. The term “sequence” may refer to an ordered set or subset. The terms “less than,” “less than or equal to,” “greater than,” and “greater than or equal to,” may be used herein to describe the relations between various objects or members of ordered sets or sequences; these terms will be understood to refer to any appropriate ordering relation applicable to the objects being ordered.

The term “tool” can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

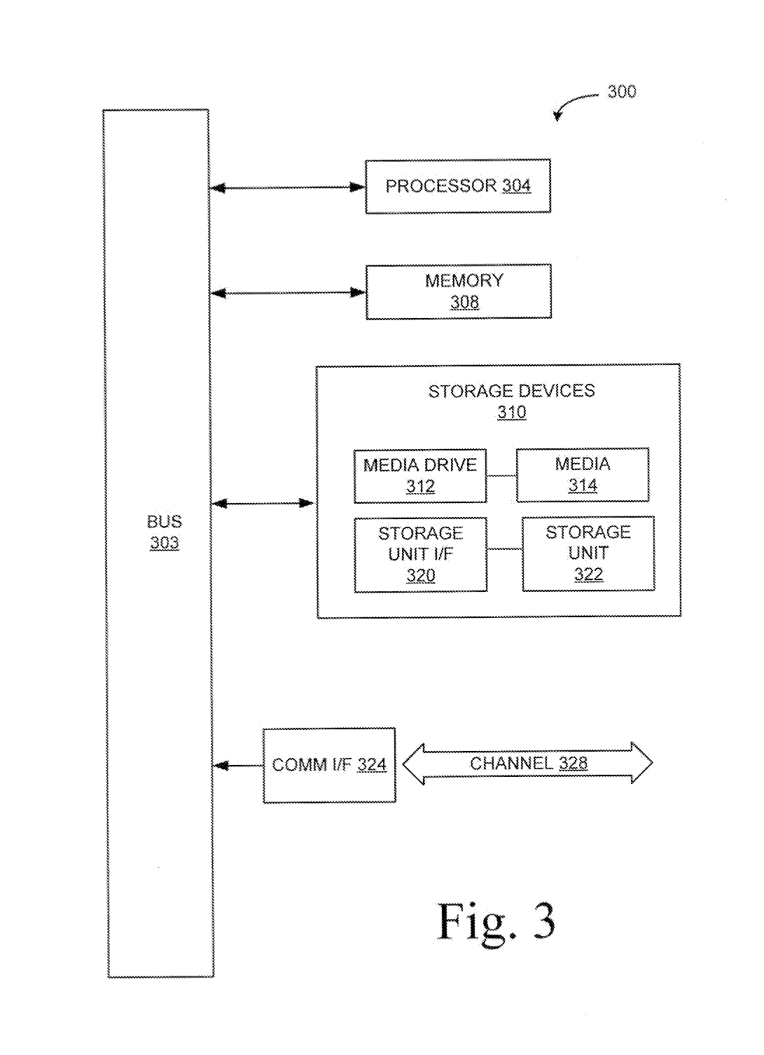

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 300. After reading this description, it will become apparent to a person skilled in the relevant art how to implement the invention using other computing modules or architectures.

Referring now to FIG. 3, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 303, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 303 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD, DVD or Blu-ray drive (R or RW), or other removable or fixed media drive might be provided. Accordingly, storage media 314 might include, for example, a hard disk, a floppy disk, magnetic tape, cartridge, optical disk, a CD, DVD or Blu-ray, or other fixed or removable medium that is read by, written to or accessed by media drive 312. As these examples illustrate, the storage media 314 can include a non-transitory computer readable medium having computer executable program code embodied thereon.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to:
receive an order for cutting a contact lens from a contracted manufacturer at an exchange;
uniquely identify and authorize the manufacturer and a user entering the order;
pre-validate the order for consistency based on predetermined rules;
place the order with an exchange engine and authenticate the order;
determine whether a required parameter file is already generated and available via a cutting file database;
if the required parameter file already exists, instruct the cutting file database to package the available data and deliver the appropriate encrypted package back to the engine for delivery to a lathe gateway computer;
if the required parameter file does not exist, forward the order to a lathe file generator to create the parameter file and enter it into the cutting file database; and
deliver the encrypted package to the lathe gateway computer.

2. The computer readable medium of claim 1, wherein the order is received via a Web based solution or a mobile device based solution.

3. The computer readable medium of claim 1, wherein the manufacturer and user are uniquely identified and authorized by verifying a userID and password entered by the person

4. The computer readable medium of claim 1, wherein the computer executable program code is further configured to cause the computing device to require the manufacturer to certify in order to produce a particular lens type

5. The computer readable medium of claim 1, wherein the computer executable program code is further configured to cause the computing device to restrict the user to only order product authorized for the selected manufacturer to produce.

6. The computer readable medium of claim 1, wherein the order is authenticated using a two-step, two-tier authentication system wherein the communication is encrypted and then authorized using a unique identifier assigned to the user.

7. The computer readable medium of claim 1, wherein the exchange engine listens for an incoming encrypted order request using an Internet based order process, an internal job fulfillment request, or a poll from a manufacturer lathe gateway computer requesting order fulfillment.

8. A system, comprising:
means for receiving an order for cutting a contact lens from a contracted manufacturer at an exchange;
means for uniquely identifying and authorizing the manufacturer and a user entering the order;
means for pre-validating the order for consistency based on predetermined rules;
means for placing the order with an exchange engine and authenticating the order;
means for determining whether a required parameter file is already generated and available via a cutting file database;
means for instructing the cutting file database to package the available data and deliver the appropriate encrypted package back to the engine for delivery to a lathe gateway computer if the required parameter file already exists;
means for forwarding the order to a lathe file generator to create the parameter file and enter it into the cutting file database if the required parameter file does not exist; and
means for delivering the encrypted package to the lathe gateway computer.

9. The system of claim 8, further comprising means for requiring the manufacturer to certify in order to produce a particular lens type.

10. The system of claim 8, further comprising means for authenticating the order using a two-step, two-tier authentication process wherein the communication is encrypted and then authorized using a unique identifier assigned to the user.

11. The system of claim 8, further comprising a means for determining whether the required parameter file is already generated and available via cutting file database.

12. A method for contact lens cutting file distribution, comprising:
providing a dedicated gateway computer provisioned with a scheduling and order entry module that accepts an order from an exchange engine, the order including lens parameters, patient information and order placement;
securely downloading a lathe cutting file; and
providing an interface to a lathe to transfer the cutting file in order to complete a cutting process.

13. The method of claim 12, further comprising cutting a contact lens according to the lens parameters.

14. The method of claim 13, further comprising determining whether the order is complete.

15. The method of claim 14, further comprising securely deleting the lathe file if the order is complete.

16. The method of claim 12, further comprising updating internal databases identifying the completion of the order and invoicing for royalty payments.

17. The method of claim 12, further comprising polling proprietary servers on a pre-set timer for updated statuses or work order payload.
